(19) United States
(12) Patent Application Publication
(10) Pub. No.: US 2007/0019043 A1
(43) Pub. Date: Jan. 25, 2007

(54) Liquid-jet head and liquid-jet apparatus, and methods for manufacturing the same

(76) Inventor: Kazufumi Oya, Suwa (JP)

Correspondence Address: HARNESS, DICKEY & PIERCE, P.L.C., P.O. BOX 828, BLOOMFIELD HILLS, MI, 48303, US

(21) Appl. No.: 11/489,185

(22) Filed: Jul. 19, 2006

(30) Foreign Application Priority Data
Jul. 20, 2005 (JP) 2005--209754
Apr. 25, 2006 (JP) 2006-121092

(51) Int. Cl. B41J 2/045

(52) U.S. Cl. 347/70

(57) ABSTRACT

A liquid-jet head includes a nozzle substrate, a cavity substrate, and a reservoir substrate. The nozzle substrate has nozzle holes through which liquid is jetted as droplets. The cavity substrate includes a vibration plate for pressurizing the liquid and first recesses corresponding to the nozzle holes. The reservoir has a second recess serving as a reservoir for storing liquid, delivering holes formed in the bottom of the second recess, nozzle communication holes communicating with the nozzle holes, and third recesses formed on the opposite side to the second recess. The reservoir substrate is bonded to the cavity substrate so that the third recesses are coupled with the respective first recesses to define discharge chambers, and the nozzle communication holes allow the nozzle holes to communicate with the respective discharge chambers.

The entire disclosure of Japanese Patent Application Nos. 2005-209754, filed on Jul. 20, 2005 and 2006-121092, filed on Apr. 25, 2006, is expressly incorporated by reference herein.

### BACKGROUND OF THE INVENTION

1. Field of the Invention

The present invention relates to a liquid-jet head and a liquid-jet apparatus including the liquid-jet head, and methods for manufacturing the liquid-jet head and the liquid-jet apparatus.

2. Description of the Related Art

Liquid-jet systems represented by an ink jet system in which ink is jetted for printing are used, for example, for printing in all fields including household use and industrial use. In the liquid-jet system, a microfabricated device, such as a liquid-jet head including a plurality of nozzles, is relatively moved with respect to an object and jets a liquid to a predetermined position on the object. The liquid-jet system has also been used for manufacturing color filters for liquid crystal display devices, display units including organic electroluminescence devices (hereinafter referred to as OEL devices), and microarrays of DNA, biomolecules, or the like, in recent years.

A type of the liquid-jet head embodying the liquid-jet system has discharge chambers for containing liquid to be jetted. Each discharge chamber is structured so that at least one wall (bottom wall, in this instance, which is integrated to other walls, and which may be referred to as vibration plate) of the discharge chamber is bent and deformed. The deformation of the vibration plate increases the pressure in the discharge chamber, so that the liquid is jetted through a nozzle communicating with the discharge chamber. For manufacturing this type of liquid-jet head, glass or silicon substrates are used as the material. These substrates are provided with functional structures, and are then stacked and bonded to one another, as disclosed in, for example, Japanese Unexamined Patent Application Publication No. 2003-170604.

The nozzles of the liquid-jet head tend to be densely formed more and more. As the intervals between the nozzles are reduced, the intervals between the discharge chambers are also reduced. Accordingly, the vibration of any one of the discharge chambers undesirably affects the liquid in the adjacent discharge chambers. In order to reduce this adverse effect, it is necessary to reduce the height of the discharge chambers. In view of such circumstances, a structure has been proposed and is being practiced in which a common liquid chamber called reservoir, which is conventionally formed on the same substrate together with discharge chambers, is formed separately on another substrate (hereinafter referred to as reservoir substrate), and the reservoir substrate is stacked on the substrate having the discharge chambers.

In the liquid-jet head having this structure, the reservoir substrate is provided with functional structures by dry etching. Unfortunately, dry etching limits the increase of throughput in view of processing time and the number of substrates that can be processed at one time. The reservoir substrate is provided with a through hole. Unfortunately, when the substrate is placed and fixed on a supporting stand, which generally contains a substrate-cooling gas, the cooling gas is released through the through hole. Accordingly, another support base is required.

### SUMMARY

The present invention overcomes the above-described disadvantages and provides a liquid-jet head including an efficiently and precisely prepared reservoir substrate, a liquid-jet apparatus including the liquid-jet head, and methods for manufacturing the same at high throughput and high yield.

According to an aspect of the present invention, a liquid-jet head including a nozzle substrate, a cavity substrate, and a reservoir substrate is provided. The nozzle substrate has a plurality of nozzle holes through which liquid is jetted as droplets. The cavity substrate includes vibration plates for applying pressure to the liquid and a plurality of first recesses corresponding to the respective nozzle holes. The reservoir substrate has a second recess serving as a reservoir for storing liquid to be supplied to the first recesses, a plurality of delivering holes formed in the bottom of the second recess to allow the second recess to communicate with the first recesses, a plurality of nozzle communication holes to allow the first recesses to communicate with the respective nozzle holes, and a plurality of third recesses formed on the opposite side to the second recess, corresponding to the respective first recesses. The reservoir substrate is bonded to the cavity substrate, so that the third recesses are coupled with the respective first recesses to define discharge chambers.

The third recesses formed in the reservoir substrate can increase the capacity of the discharge chambers in combination with the first recesses formed in the cavity substrate. Consequently, the flow resistance in the entirety of the liquid-jet head can be reduced, and the nozzles can be closely arranged. Thus, the liquid-jet head can exhibit high jetting performance.

Preferably, the reservoir substrate is made of silicon.

Such a reservoir substrate can be prepared by a microfabrication technique, such as etching, used in a semiconductor process, or a microelectromechanical system (MEMS).

Preferably, the reservoir substrate is made of a monocrystalline silicon substrate whose surface is oriented in the (100) plane.

The use of a (100)-oriented monocrystalline silicon substrate for the reservoir substrate allows uniform etching parallel to the surface of the silicon substrate in wet etching to form the second recess intended for the reservior, thus allowing precise control of the length of the delivering holes for delivering the liquid to the discharge chambers.

Each third recess may have a height of 0.8 to 1.0 time that of the first recesses and a width of 0.3 to 0.5 time that of the first recesses.

By appropriately setting the proportions between the height and width of the first recesses and those of the third recesses, crosstalk can be prevented, and the discharge chambers have increased capacities to reduce the flow resistance. Thus, the jetting performance can be enhanced.

The nozzle communication holes may directly communicate with the respective third recesses in a multi-step structure.

Since the nozzle communication holes directly communicate with the third recesses, the liquid flow in the discharge chamber is smooth with no obstacles and, thus, the flow resistance can be reduced. If the communication between the nozzle communication holes and the third recesses is indirect or demarcated, the jetting performance can be controlled by appropriately setting the height of the region for demarcating the communication.

According to another aspect of the present invention, a liquid-jet apparatus including the above-mentioned liquid-jet head is provided.

The liquid-jet head has discharge chambers having a large capacity because of the third recesses formed in the reservoir substrate. Accordingly, the liquid-jet apparatus can exhibit high jetting performance.

According to another aspect of the present invention, a method for manufacturing a liquid-jet head including a plurality of nozzles through which liquid is jetted as droplets, a plurality of discharge chambers each having a vibration plate for applying pressure to the liquid, and a reservoir for storing the liquid to be supplied to the discharge chambers, includes a step of preparing a reservoir substrate. The step includes sub steps of: forming a recess intended for the reservoir in a substrate by wet etching, and forming delivering holes serving as passages between the discharge chambers and the reservoir, nozzle communication holes serving as passages between the discharge chambers and the nozzles, and a plurality of recesses intended for part of the discharge chambers, in the substrate by dry etching.

Since the recess intended for the reservoir is formed in a substrate by wet etching and the other portions are formed by dry etching, the processing time of the reservoir, which is formed by etching a large area, can be reduced. Furthermore, a plurality of substrates (wafers) can be etched at one time, and accordingly the process time can be reduced and the throughput can be increased.

The present invention is also directed to another method for manufacturing a liquid-jet head including a plurality of nozzles through which liquid is jetted as droplets, a plurality of discharge chambers each having a vibration plate for applying pressure to the liquid, and a reservoir for storing the liquid to be supplied to the discharge chambers. This method includes a step of preparing a reservoir substrate. The step includes the sub steps of: forming delivering holes serving as passages between the discharge chambers and the reservoir, and a plurality of recesses intended for part of the discharge chambers, in a substrate by dry etching; forming pre-holes for forming nozzle communication holes serving as passages between the discharge chambers and the nozzles, in the substrate by laser processing; and then forming the nozzle communication holes and a recess intended for the reservoir in the substrate by wet etching.

By forming pre-holes passing through the regions intended for the nozzle communication holes by laser processing, and then forming the nozzle communication holes and a recess intended for the reservoir by wet etching, the manufacture time and cost can be reduced in comparison with the case where the nozzle communication holes are formed by dry etching.

The dry etching may be performed using a silicon oxide film as an etching mask. First, a portion of the etching mask corresponding to a region to be etched to the greatest depth is removed and then the substrate is dry-etched, subsequently a portion of the etching mask corresponding to a region to be etched to the second greatest depth is removed and then the substrate is dry-etched again, and the dry etching is thus repeated in decreasing order of etching depth to form a multi-step structure in the substrate.

By repeating patterning of a silicon oxide etching mask once formed by, for example, wet thermal oxidation and subsequent etching from one portion to another, a multi-step structure having different depths can be formed in the reservoir substrate.

Alternatively, the dry etching may be preformed using a resist mask. First, a portion of the resist mask corresponding to a region to be etched to the greatest depth is removed and then the substrate is dry-etched, subsequently a portion of the resist mask corresponding to a region to be etched to the second greatest depth is removed and then the substrate is dry-etched again, and the dry etching is thus repeated in decreasing order of etching depth to form a multi-step structure in the substrate.

By repeating patterning of a resist mask once formed and subsequent etching from one portion to another, a multi-step structure having different depths can be formed in the reservoir substrate.

The resist mask may be formed of a resist on the substrate by exposing the resist with a non-contact exposure apparatus.

Use of the non-contact exposure apparatus can advantageously reduce physical damage to the resist mask in comparison with the case of patterning with the mask in close contact with the substrate. In particular, since the method of the present invention performs patterning a plurality of times on the same resist mask, patterning with the mask in close contact with the substrate can accumulate physical damage on the substrate.

The non-contact exposure apparatus may be a mirror projection aligner.

Use of the mirror projection aligner allows low-cost exposure and thus low-cost manufacture.

Alternatively, the non-contact exposure apparatus may be a stepper.

The stepper is capable of reduction exposure, and accordingly allows precise alignment and patterning. In particular, since a process requires a plurality of patternings misalignment caused between the patternings can be prevented.

The step of preparing the reservoir substrate may further includes a sub step of forming a leakage prevention layer for preventing the leakage of a cooling gas on a surface which is oppositely fixed on a supporting stand having a recess for cooling the substrate with the cooling gas delivered to the recess during the dry etching before perforating the substrate to form the nozzle communication holes.

Since a leakage prevention layer for preventing the substrate-cooling gas from leaking is formed on the substrate before forming holes through the substrate, the leakage of the cooling gas can be prevented without preparing another leakage prevention member.

The substrate may be made of silicon and the leakage prevention layer may be formed by thermal oxidation of the silicon substrate.

Consequently, the resulting oxide layer can be used as not only the leakage prevention layer, but also the etching mask and an etch stop layer. Accordingly, a specific leakage prevention layer does not need to be formed, and thus the number of process steps and cost can be reduced.

The method may further include a sub step of grinding the reservoir substrate to reduce the thickness to a predetermined thickness.

Such a process can use a silicon substrate having such a large thickness as ensures stable handling, and thus prevents breakage to increase the yield, even if the silicon substrate has a large diameter. In addition, since the silicon substrate does not need to originally have the intended thickness of the reservoir substrate, inexpensive standardized silicon substrate can be used for the reservoir substrate, and thus the material cost can be reduced. Furthermore, thinner liquid-jet heads (reservoir substrates) can be achieved and changes in specifications can be allowed.

The method may further includes the steps of preparing an electrode substrate including electrodes for actuating the vibration plates, a cavity substrate including the discharge chambers, and a nozzle substrate including the nozzles; and stacking and bonding the electrode substrate, the cavity substrate, the reservoir substrate, and the nozzle substrate in that order.

Thus, the resulting liquid-jet head has a four-layer structure including the electrode substrate, the cavity substrate, the reservoir substrate, and the nozzle substrate. This structure allows the reservoir substrate to be prepared by combination of dry etching and wet etching, and thus allows the reduction in process time, number of process steps, and cost.

According to another aspect of the present invention, a method is provided for manufacturing a liquid-jet apparatus, and which include a step of preparing the liquid-jet head by the above-described method for manufacturing the liquid-jet head.

In the method for manufacturing the liquid-jet apparatus, the reservoir substrate can be prepared by combination with wet etching, and thus the liquid-jet head can be manufactured in a process with a reduced process time, a reduced number of process steps, and a reduced cost. The resulting liquid-jet apparatus has such a liquid-jet head.

### BRIEF DESCRIPTION OF THE DRAWINGS

FIG. 1 is an exploded view of a liquid-jet head according to a first embodiment of the present invention;

FIG. 2 is a sectional view of the liquid-jet head;

FIGS. 3A and 3B are representations showing the relationship between the first recess and the second recess of a discharge chamber in the liquid-jet head;

FIGS. 4A to 4E are process views of a reservoir substrate used in the liquid-jet head according to the first embodiment;

FIGS. 5A to 5E are subsequent process views of the manufacture of the reservoir substrate according to the first embodiment;

FIG. 6 is a schematic diagram of a dry etching apparatus;

FIGS. 7A to 7E are process views of a reservoir substrate used in a liquid-jet head according to a second embodiment of the present invention;

FIGS. 8A to 8F are subsequent process views of the reservoir substrate according to the second embodiment;

FIG. 9 is a schematic diagram of a non-contact exposure apparatus;

FIGS. 10A to 10F are process views of a reservoir substrate used in a liquid-jet head according to a third embodiment of the present invention;

FIGS. 11A to 11D are process views of a reservoir substrate used in a liquid-jet head according to a fourth embodiment of the present invention;

FIGS. 12A to 12E are subsequent process views of the reservoir substrate according to the fourth embodiment;

FIGS. 13A to 13D are process views. of the step of bonding a silicon substrate to a support base and separating them;

FIG. 14 is an external view of a liquid-jet apparatus including a liquid-jet head; and

FIG. 15 is a schematic view of exemplary components of a liquid-jet apparatus.

### DESCRIPTION OF THE PREFERRED EMBODIMENTS

First Embodiment

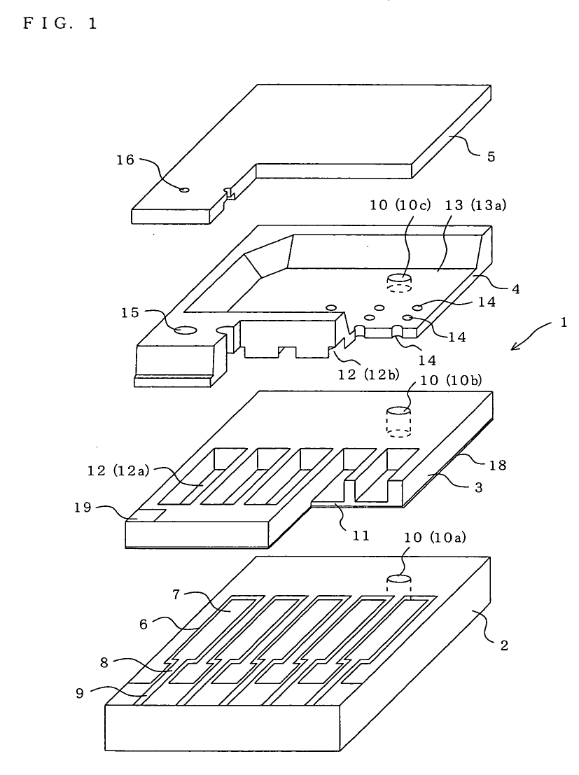

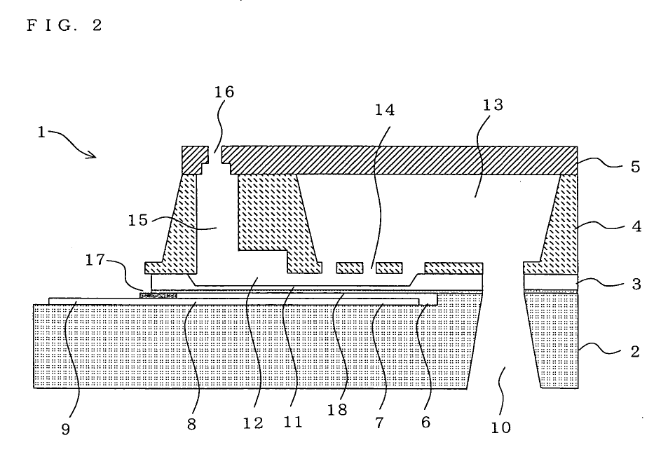

FIG. 1 is an exploded view of a liquid-jet head according to a first embodiment of the present invention, and FIG. 2 is a sectional view of the liquid-jet head. FIGS. 1 and 2 show part of the liquid-jet head. The drawings referred to herein, including FIGS. 1 and 2, may show components in different proportions for the sake of easy understanding, and the upper side and the lower side in the drawings are described as being in an upper position and a lower position respectively.

As shown in FIG. 1, the liquid-jet head 1 according to the present embodiment includes an electrode substrate 2, a cavity substrate 3, a reservoir substrate 4, and a nozzle substrate 5. These four substrates are stacked in that order from the underside. In this instance, the electrode substrate 2 and the cavity substrate 3 are joined by anodic bonding. The cavity substrate 3 and the reservoir substrate 4, and the reservoir substrate 4 and the nozzle substrate 5 are respectively bonded with an adhesive, such as that of epoxy resin.

The electrode substrate 2 is mainly constituted of a heat-resistant, hard borosilicate glass substrate with a thickness of about 1 mm. Although such a glass substrate is used in the present embodiment, a monocrystalline silicon substrate may be used, for example. The electrode substrate 2 is provided with a plurality of recesses 6 with a depth of, for example, about 0.3 μm on the surface, corresponding to first discharge chamber recesses 12a (first recesses) in the cavity substrate 3. The first discharge chamber recesses 12a define discharge chambers 12, which will be detailed below. Each recess 6 in the electrode substrate 2 has an individual electrode 7, or a fixed electrode, inside (particularly at the bottom) so as to oppose the corresponding discharge chamber 12 (or vibration plate 11), and, in addition, a lead 8 and terminal 9 that are formed in one piece with the individual electrode. In the following description, the individual electrode 7 refers to the integrated structure including the lead 8 and the terminal 9, unless otherwise stated. The recess 6 defines a gap between the vibration plate 11 and the individual electrode 7. The vibration plate 11 can be bent (displaced) in the gap. The individual electrode 7, for example, may be formed of indium tin oxide (ITO) to a thickness of about 0.1 μm inside the recess 6 by sputtering. The electrode substrate 2 is further provided with a through hole 10a that is intended to be part of a liquid supply hole 10 through which a liquid is supplied from an external reservoir (not shown).

The cavity substrate 3 is mainly constituted of a monocrystalline silicon substrate (hereinafter referred to as silicon substrate). The first discharge chamber recesses 12a (whose bottom walls serve as the vibration plates 11 acting as movable electrodes) are formed for the discharge chambers 12 in the cavity substrate 3. In addition, the lower surface (the surface opposing to the electrode substrate 2) of the cavity substrate 3 is coated with an insulating film 18 for electrically insulating the vibration plates 11 from the individual electrodes 7. The insulating film 18 is a TEOS film (a SiO₂ film formed of tetraethylorthosilicate, or tetraethoxysilane, in the present embodiment), and is formed to a thickness of about 0.1 μm by plasma chemical vapor deposition (plasma CVD, may referred to as TEOS-p CVD). As an alternative to the TEOS film, the insulating film 18 may be formed of, for example, Al₂O₃ (aluminium oxide, or alumina). The cavity substrate 3 also has a through hole 10b communicating with the through hole 10a and another through hole 10c, thereby defining the liquid supply hole 10. The gaps are secluded from the external atmosphere by a sealant 17 to prevent the entry of water and foreign matter. In addition, the cavity substrate 3 has a common electrode terminal 19 through which a charge with an opposite polarity to the individual electrodes 7 is supplied to the substrate (vibration plates 11) from an external power supply (not shown).

The reservoir substrate 4 is mainly constituted of, for example, a silicon substrate. In the present embodiment, a silicon substrate having a (100)-oriented surface is used. The reservoir substrate 4 has a reservoir recess 13a (second recess) intended for a reservoir (common liquid chamber) 13 from which the liquid is supplied to the discharge chambers 12. The reservoir substrate 4 also has a through hole 10c through the bottom of the reservoir recess 13a. The through hole 10c communicates with the through holes 10a and 10b, thereby defining the liquid supply hole 10. The bottom of the reservoir substrate 4 further has delivering holes 14 corresponding to the positions of the discharge chambers 12 so as to deliver the liquid from the reservoir 13 to the discharge chambers 12. In the present embodiment, three delivering holes 14 are provided for each discharge chamber 12. Alternatively, for example, the three delivering holes 14 may be integrated into one hole, and below-described second discharge chamber recesses 12b may be extended according to the delivery hole 14. In addition, the reservoir substrate 4 has a plurality of nozzle communication holes 15 corresponding to respective nozzle holes 16 (discharge chambers 12) formed in the nozzle substrate 5. Each nozzle communication hole 15 is located between the discharge chamber 12 and the nozzle hole 6, and serves as a passage through which the liquid pressured in the discharge chamber 12 is delivered to the nozzle hole 16.

Furthermore, the reservoir substrate 4 has second discharge chamber recesses 12b (third recesses) on the surface in contact with the cavity substrate 3. The second discharge chamber recesses 12b are coupled with the respective first discharge chambers 12a of the cavity substrate 3 to define part of discharge chambers 12. The second discharge chamber recess 12b and the nozzle communication hole 15 may be demarcated by leaving part of the silicon substrate. However, in the present embodiment, the second discharge chamber recess 12b is integrated with the nozzle communication hole 15 in order to reduce the flow resistance.

The nozzle substrate 5 is mainly constituted of, for example, a silicon substrate as well. The nozzle substrate 5 has a plurality of nozzle holes 16. Liquid delivered through the nozzle communication holes 15 is jetted as droplets through the respective nozzle holes 16 to the outside. By forming the nozzle holes 16 in a multi-step structure, it is expected that the liquid is jetted straight on. In the present embodiment, the nozzle holes 6 are formed in a two-step structure. Also, a diaphragm (not shown) may be provided to absorb the pressure applied to the liquid at the reservoir 13 side from vibration plate 11.

FIGS. 3A and 3B show the relationship in height and width between the first discharge chamber recess 12a and the second discharge chamber recess 12b. FIG. 3A is a graph of the amount of crosstalk (CT) and the ratio of flow resistance (R ratio) for combinations of the height h and width d of the second discharge chamber recess 12b when the first discharge chamber recess 12a has a height (depth) of 36 μm and a width of 30 μm as shown in FIG. 3B. The ideal CT amount is 1 (no crosstalk occurs), but in the present embodiment, 0.95 or more is acceptable. The R ratio is expressed by a value in the ratio of the flow resistance of an entire discharge chamber to that of a discharge chamber having only the first discharge chamber recess 12a, but no second discharge chamber recess 12b; hence, R ratio =1 when there is no second discharge chamber recess 12b. The smaller the R ratio, the lower the flow resistance. FIG. 3 suggests that when h =4.5 μm, the flow resistance is not reduced effectively, and that the flow resistance can be reduced effectively with a CT amount within the acceptable range when d is in the range of about 10 to 15 μm (about 0.3 to 0.5 time the width of the first discharge chamber recess 12a) and h is in the range of about 28 to 36 μm (about 0.8 to 1.0 time the height of the first discharge chamber recess 12a). It is therefore thought that a preferred second discharge chamber recess 12b, if it is provided, has a width of about 0.3 to 0.5 time that of the first discharge chamber recess 12a and a height of about 0.8 to 1.0 time that of the first discharge chamber recess 12a from the viewpoint of increasing the jetting performance.

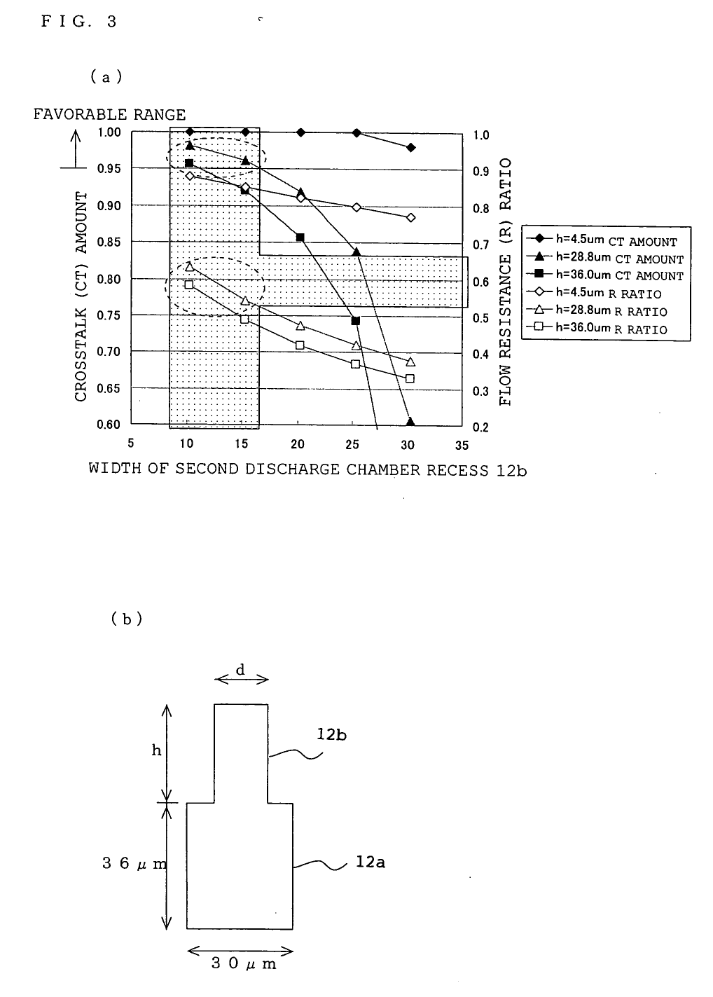

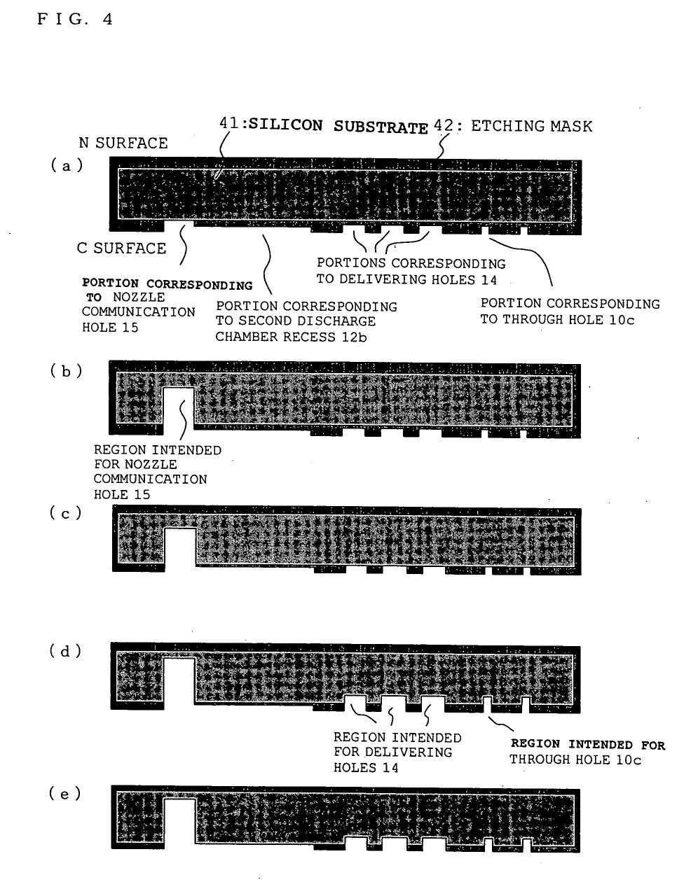

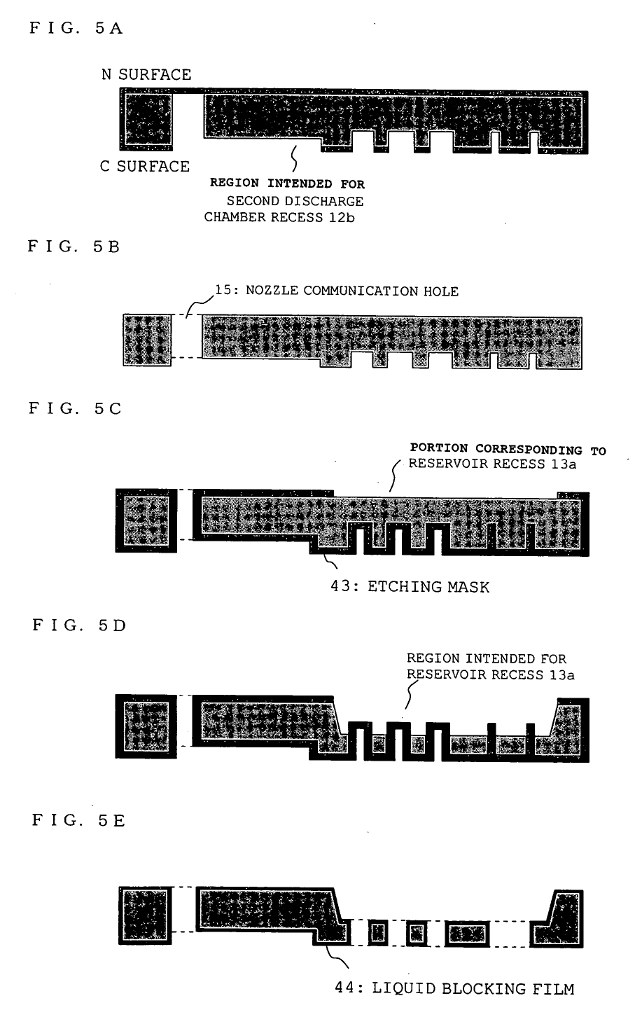

FIGS. 4A to 4E and 5A to 5E are process views of the reservoir substrate 4 of the liquid-jet head according to the first embodiment. The manufacture process of the reservoir substrate 4 will now be described with reference to these figures. Although in practice a plurality of reservoir substrates 4 are formed in a wafer, FIGS. 4A to 4E and 5A to 5E simply show a part of the wafer.

For example, an etching mask 42 is formed of silicon oxide over the entire surface of a silicon substrate 41 with a thickness of about 180 μm whose surface is oriented in (100) plane (hereinafter referred to as the silicon substrate 41) by thermal oxidation (wet thermal oxidation in the present embodiment) or the like. The etching mask 42 of the present embodiment serves as an etch stop layer and a leakage prevention layer, as well as serving as a mask.

The etching mask 42 on the surface (hereinafter referred to as the C surface) of the silicon substrate 41 intended to be in contact with the cavity substrate 3 is patterned and etched with a hydrofluoric acid-based solution or the like to remove the portions of the etching mask 42 corresponding to the nozzle communication holes 15, the second discharge chamber recesses 12b, the through hole 10c(liquid supply hole 10), and the delivering holes 14, as shown in FIG. 4A.

For the removal, while the portions corresponding to the nozzle communication holes 15 of the etching mask 42 are completely removed to expose the surface of the silicon substrate 41, the portions corresponding to the delivering holes 14, the through hole 10c, and the second discharge chamber recesses 12b of the etching mask 42 are subjected to half etching to be left partially. In this instance, the half etching is performed such that the portions corresponding to the delivering holes 14 and the thorough hole 10c of the etching mask 42 have a smaller thickness than the portions corresponding to the second discharge chamber recesses 12b of the etching mask 42. For the through hole 10c, the entirety of the portion corresponding to the through hole 10c is not etched, but only the outer region is etched.

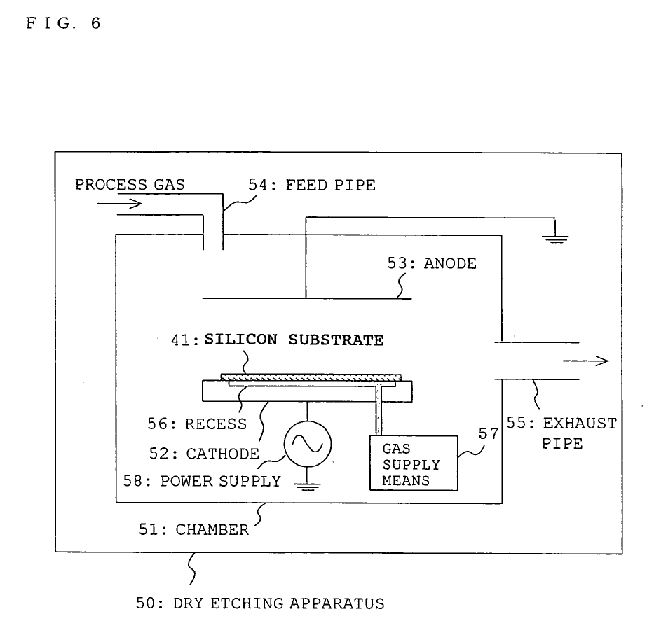

FIG. 6 shows a dry etching apparatus. The chamber 51 of the dry etching apparatus 50 contains, for example, a chuck mechanism serving as a supporting stand (stage) on which the silicon substrate 41 is placed and fixed, a cathode 52 to which power is supplied from a power supply 58, and an anode 53 serving as the opposing electrode to the cathode 52. The dry etching apparatus 50 further includes a feed pipe 54 through which a process gas used for etching is supplied to the chamber 51, and an exhaust pipe 55 through which a pump (not shown) evacuates the chamber, and thus the pressure in the chamber 51 is kept constant.

The cathode 52 has, for example, a recess 56. The recess 56 is filled with a substrate-cooling gas such as helium delivered from, for example, a gas supply means 57 to prevent the silicon substrate 41 from being overheated. Overheating of the silicon substrate 41 may affect the etching speed, or may cause the silicon substrate 41 to degenerate by, for example, oxidation. If the silicon substrate has a resist mask, the resist may be burned. Accordingly, the temperature of the silicon substrate 41 should be kept low. In this instance, the silicon substrate 41 serves as a cover to prevent the substrate-cooling gas from leaking into the chamber 51.

The silicon substrate 41 is placed in the chamber 51 of the dry etching apparatus 50 as shown in FIG. 6, in such a manner that the surface (hereinafter referred to as the N surface) of the silicon substrate 41 intended to be in contact with the nozzle substrate 5 opposes the cathode 52. In this state, the regions intended for the nozzle communication holes 15 are dry-etched to form holes of about 150 μm in depth (height) from the C surface side by, for example, ICP (Inductively Coupled Plasma) discharge, as shown in FIG. 4B. For the dry etching, any technique and any process gas can be employed as long as the silicon substrate 41 can be etched. For example, sulfur hexafluoride (SF₆) may be used as the process gas.

Subsequently, half etching of the etching mask 42 is further performed so that the portions corresponding to the delivering holes 14 and the liquid supply hole 10 of the etching mask 42 are completely removed to expose the surface of the silicon substrate 41 and that the portions corresponding to the second discharge chamber recesses 12bof the etching mask 42 are partially left (FIG. 4C).

Then, the regions intended for the nozzle communication holes 15, the delivering holes 14, and the through hole 10care dry-etched at a depth of about 25 μm from the C surface side by, for example, ICP discharge (FIG. 4D). Consequently, the regions intended for the nozzle communication holes 15 are dry-etched to a depth of about 175 μm.

Then, the portions corresponding to the second discharge chamber recesses 12b of the etching mask 42 are completely removed to expose the silicon substrate 41 by half etching of the etching mask 42 (FIG. 4E). Subsequently, the C surface side is subjected to dry etching by, for example, ICP discharge at a depth of about 25 μm (FIG. 5A). Thus, the regions intended for the nozzle communication holes 15 are completely dry-etched to form holes through the silicon substrate 41 while the etching mask 42 is left without being completely removed (with etch stop) because of its high selectivity. Consequently, the regions intended for the delivering holes 14 and the through hole 10c are dry-etched ultimately to a depth of about 50 μm. As for the N surface of the silicon substrate 41, which opposes the cathode 52, if no countermeasure is devised for preventing the leakage of the substrate-cooling gas, the leakage occurs through the holes formed through the-silicon substrate 41. In the present embodiment, however, the holes formed through the silicon substrate 41 do not extend through the etching mask 42. Thus, the etching mask 42 serves not only as a mask, but also as a leakage prevention layer for preventing the leakage of the substrate-cooling gas delivering to the cathode 52.

After the completion of dry etching, the remainder of the etching mask 42 is removed by etching using a hydrofluoric acid-based solution or the like (FIG. 5B). The resulting silicon substrate 41 with no etching mask 42 is subjected again to thermal oxidation or the like to form a silicon oxide etching mask 43 over the surfaces. In this instance, since the subsequent steps will not perform dry etching, the nozzle communication holes 15 do not need to be covered. Then, the region corresponding to the reservoir recess 13a (intended for the reservoir 13) of the etching mask 43 on the N surface is completely removed for subsequent wet-etching (FIG. 5C).

Subsequently, the silicon substrate is immersed in, for example, an aqueous solution of potassium hydroxide (KOH) to form the reservoir recess 13a to a depth of about 150 μm (FIG. 5D). In order to balance the etching speed with the prevention of surface roughness, solutions of several concentrations of potassium hydroxide in water may be prepared, and the silicon substrate may be immersed in the solutions in decreasing order of concentration. After the completion of wet etching, the remainder of the etching mask 43 is removed with a hydrofluoric acid-based solution or the like. At the same time, the silicon left in the region intended for the through hole 10c is simultaneously removed from the silicon substrate 41. The resulting silicon substrate 41 is further subjected to, for example, dry thermal oxidation to form a liquid blocking film 44 to a thickness of, for example, about 0.1 μm. The reservoir substrate 4 is thus completed (FIG. 5E).

The completed reservoir substrate 4 is stacked together with the other substrates in this order: the electrode substrate 2, the cavity substrate 3, the reservoir substrate 4, and the nozzle substrate 5. The stack is diced so that the liquid-jet heads (head chips) prepared on a wafer are separated from each other. The liquid-jet head is thus completed.

In the first embodiment, the second discharge chamber recesses 12b intended for part of discharge chambers 12 are formed in the reservoir substrate 4, which is provided to alleviate crosstalk resulting from close arrangement of nozzle holes 16 and to reduce the flow resistance. This compensates the capacity of the first discharge chamber recess 12a reduced owing to the reduction of the cavity substrate 3 thickness, and increases the entire capacity of the discharge chamber 12. Consequently, the flow resistance in the entirety of the liquid-jet head 1 can be reduced, and the resulting liquid-jet head 1 can have a high nozzle density and exhibit high jetting performance. In particular, by forming the second discharge chamber recess 12b with a height (depth) of 0.8 to 1.0 time that of the first discharge chamber recess 12a and a width of 0.3 to 0.5 time that of the first discharge chamber recess 12a, the jetting performance can be enhanced. Also, the nozzle communication hole 15 directly communicates with the second discharge chamber recess 12b in a continuous multi-step structure, so that nothing interferes with the flow of the jetting liquid and thus the flow resistance can be reduced.

In addition, since the reservoir substrate 4 is made of a silicon substrate or wafer, techniques such as of semiconductor manufacturing processes and MEMS can be applied to its preparation. In particular, the use of a (100)-oriented monocrystalline silicon substrate for the reservoir substrate 4 allows wet etching to be uniformly performed parallel to the surface of the silicon substrate with the etching variation reduced, thus allowing precise control of the length of the delivering holes 14 for delivering the liquid to the discharge chambers 12.

Also, since in the preparation of the reservoir substrate 4, etching for the reservoir recess 13a intended for the reservoir 13, which has a large area and is formed by a large amount of etching, is performed by wet etching, a plurality of substrates or wafers can be processed at one time by immersion or the like. Thus, the processing time and cost can be reduced. In addition, the single-layer etching mask 42 formed in a single step by, for example, thermal oxidation is removed as required by half etching or the like, and then dry etching is performed. Since the reservoir substrate 4 is prepared by repeating half etching and dry etching, a multi-step structure with several depths can be formed in the reservoir substrate 4, using the etching mask 42 once formed in a single step. The etching mask 42 can serve as a leakage prevention layer to prevent the leakage of the substrate-cooling gas filling the cathode 52, as well as serving as a mask. The etching mask 42 can also serve as an etch stop layer for dry etching. Since the etching mask 42 serves as a mask and a leakage prevention layer, an additional leakage prevention layer is not required. Accordingly, the number of process steps and cost can be reduced.

Second Embodiment

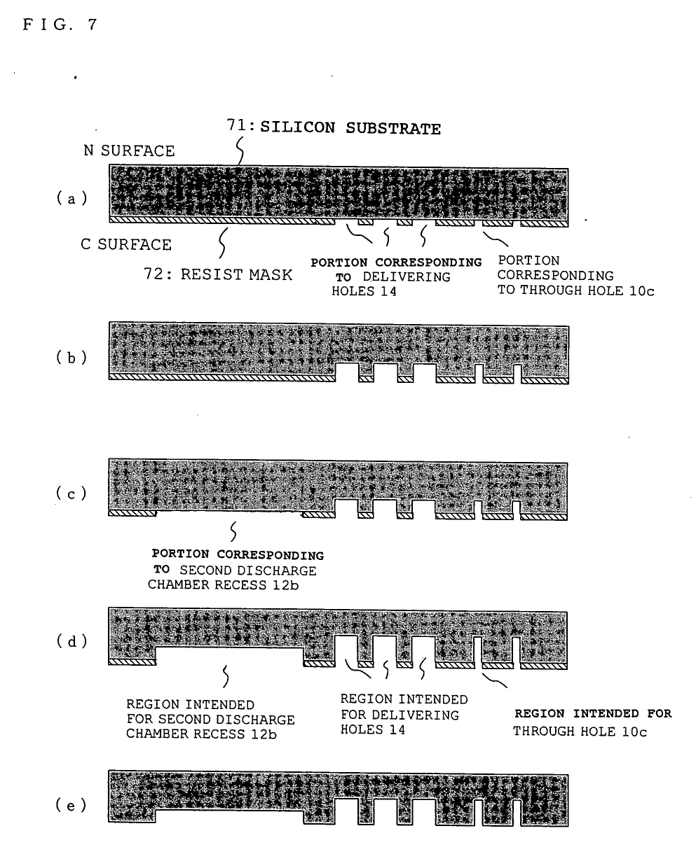

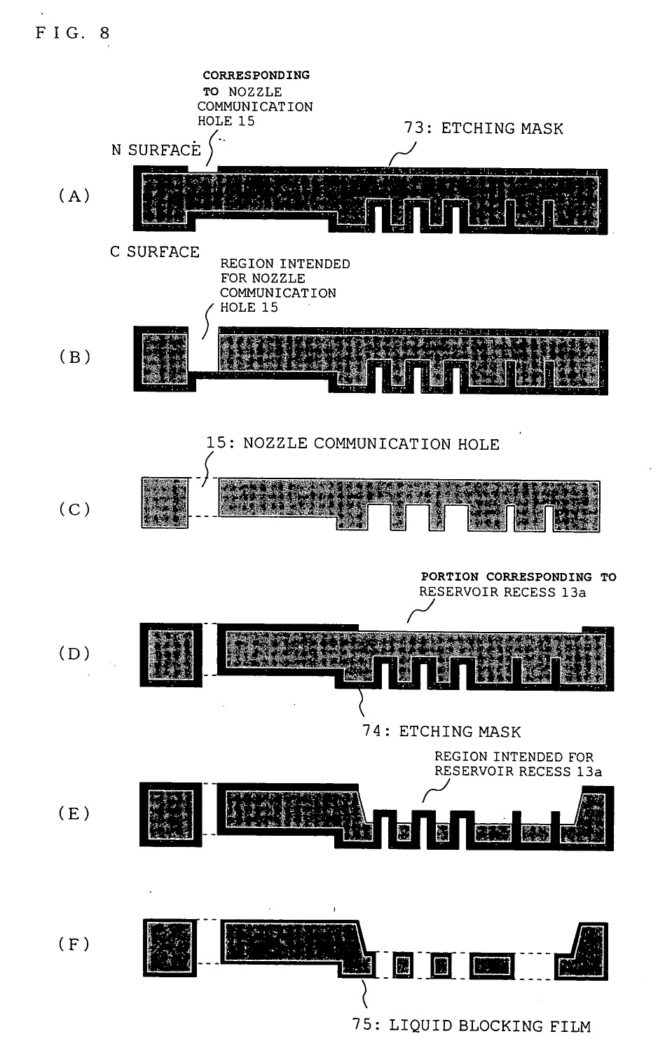

FIGS. 7A to 7E and 8A to 8F are process views of a reservoir substrate 4 of a liquid-jet head according to a second embodiment of the present invention. The manufacture process of the reservoir substrate 4 will now be described with reference to these figures.

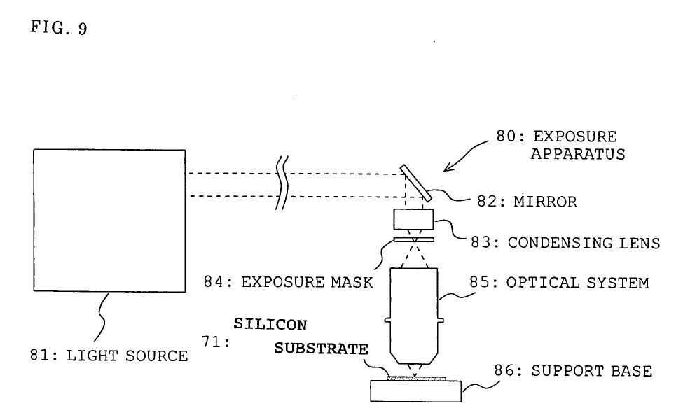

FIG. 9 is a schematic view of a non-contact exposure apparatus. In the present embodiment, the exposure apparatus 80 is a stepper capable of reduction exposure. In the exposure apparatus 80 shown in FIG. 9, light emitted from a light source 81 is reflected at a mirror 82 and condensed through a condensing lens 83. The condensed light passes through an exposure mask (reticle) 84 for patterning a resist mask 72, and enters an optical system 85. The optical system 85 includes a condensing lens (not shown) for size reduction through which the pattern of the exposure mask 84 is reduced in size at a predetermined rate and projected onto a silicon substrate 71 (wafer) placed on a support base 86, thus exposing a resist applied on the substrate to light. The exposure is performed for every several chips on a wafer in a step-and-repeat manner. While in the present embodiment, a stepper is used as the exposure apparatus, a mirror projection aligner, which can perform 1× magnification exposure at low cost without reduction, may be used as the exposure apparatus. The mirror projection aligner can perform one-shot exposure, depending on the size of the wafer, and can reduce the process time and accordingly save time.

A resist intended for a resist mask 72 is applied on the C surface of a silicon substrate 71 by, for example, spin coating. The resist is exposed to be patterned by the above-described exposure apparatus 80. Portions corresponding to the delivering holes 14 and the through hole 10c are removed from the resist, and thus the resist mask 72 is formed on the silicon substrate 71 (FIG. 7A). Subsequently, regions intended for the delivering holes 14 and the through hole 10c are dry-etched from the C surface to a depth of about 25 μm by, for example, ICP discharge (FIG. 7B).

The resist mask 72 is further patterned to expose the surfaces of the silicon substrate 71 in regions corresponding to the second discharge chamber recesses 12b(partially including the region corresponding to the nozzle communication holes 15) (FIG. 7C). Then, regions intended for the second discharge chamber recesses 12b, the delivering holes 14, and the through hole 10c are dry-etched from the C surface to a depth of about 25 μm by, for example, ICP discharge. Consequently, the regions intended for the delivering holes 14 and the through hole 10c are dry-etched to a depth of about 50 μm in total (FIG. 7D). After the dry etching, the resist mask 72 on the C surface is completely removed (FIG. 7E).

The resulting silicon substrate 71 with no resist mask 72 is provided with a silicon oxide etching mask 73 over the entire surface by thermal oxidation or the like. The etching mask 73 on the N surface side is subjected to resist patterning and etched with a hydrofluoric acid-based solution or the like. The portions corresponding to the nozzle communication holes 15 of the etching mask 73 are thus removed (FIG. 8A). While in the present embodiment, the removal of the etching mask 73 is performed from the N surface side, the etching mask 73 may be removed from the C surface side. Then, the regions intended for the nozzle communication holes 15 are dry-etched from the N. surface side by, for example, ICP discharge to perforate the region intended for the nozzle communication holes 15. In the present embodiment as well, the etching mask 73 serves as an etch stop layer and a leakage prevention layer to prevent the substrate-cooling gas from leaking (FIG. 8B). After the completion of dry etching, the etching mask 73 is removed by etching using a hydrofluoric acid-based solution or the like (FIG. 8C).

The resulting silicon substrate 71 with no etching mask 73 is provided again with a silicon oxide etching mask 74 by thermal oxidation or the like. Then, in order to wet-etch the region intended for the reservoir recess 13a, the portion corresponding to the reservoir recess 13a of the etching mask 74 on the N surface is completely removed (FIG. 8D). Then, the silicon substrate is immersed in, for example, an aqueous solution of potassium hydroxide (KOH), and thus the reservoir recess 13a is formed to a depth of about 150 μm (FIG. 8E).

After the completion of wet etching, the etching mask 74 is completely removed by etching using a hydrofluoric acid-based solution or the like. Subsequently, a liquid blocking film 75 is formed to a thickness of about 0.1 μm by, for example, dry thermal oxidation. Thus, the reservoir substrate 4 is completed (FIG. 8F).

Since in the second embodiment, dry etching is repeatedly performed in parallel with the desired patterning. and removal of the resist mask 72, a multi-step structure with several depths can be formed in the resulting reservoir substrate 4, using the resist mask 72 once formed in a single step. Since a non-contact exposure apparatus is used for forming and patterning the resist mask 72, physical damage of the resist mask 72 can be reduced in comparison with the case of patterning with the mask brought in close contact with the substrate. The non-contact exposure apparatus is particularly suitable for the present embodiment, because the resist mask 72 is subjected to patterning several times. For this patterning, use of an exposure apparatus such as a mirror projection aligner allows several times of patterning at low cost. Also, use of a reduction exposure apparatus such as a stepper allows precise alignment and patterning. In particular, the reduction exposure apparatus is suitable for the present embodiment requiring a plurality of times of precise patterning.

Third Embodiment

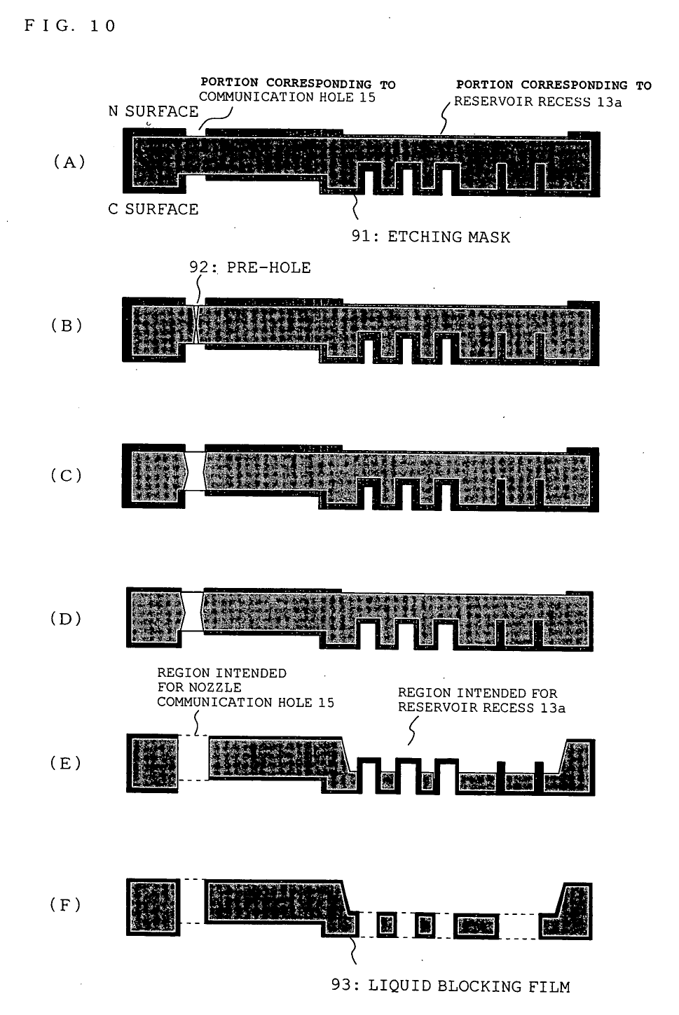

FIGS. 10A to 10F are process views of a reservoir substrate 4 of a liquid-jet head according to a third embodiment of the present invention. The preparation of the reservoir substrate 4 will now be described with reference to these figures. In the present embodiment as well, the steps shown in FIGS. 7A to 7E are performed in the same manner as in the second embodiment, and the description of these steps is not repeated.

After the steps shown in FIGS. 7A to 7E, a silicon oxide etching mask 91 is formed over the entire surface of the silicon substrate by thermal oxidation or the like. Subsequently, portions corresponding to the nozzle communication holes 15 and the reservoir recess 13a of the etching mask 91 are removed by resist patterning and etching with a hydrofluoric acid-based solution or the like. Specifically, the portions corresponding to the nozzle communication holes 15 are completely removed so that the C surface and the N surface of the silicon substrate 71 are exposed. On the other hand, the portion corresponding to the reservoir recess 13a of the etching mask 91 is half removed so as to be partially left (FIG. 10A).

A pre-hole (pilot hole) 92 is formed in each region intended for the nozzle communication holes 15 by laser processing (FIG. 10B). In this step, complete nozzle communication holes 15 do not need to be formed, and the pre-hole 92 is intended to facilitate the permeation of the etchant used in a subsequent wet etching step. For. the laser processing, any laser may be used without particular limitation as long as it can form a hole with a smaller diameter than the nozzle communication holes 15. Typical lasers include YAG (yttrium-aluminum-garnet) lasers and excimer lasers. Subsequently, the regions intended for the nozzle communication holes 15 of the silicon substrate are wet-etched with an aqueous solution of potassium hydroxide to remove these regions (FIG. 10C). In this step as well, complete nozzle communication holes 15 do not need to be formed and the nozzle communication holes 15 are completed by a subsequent wet etching step.

The remaining etching mask 91 is subjected to half etching to expose the surface of the silicon substrate 61 in the region intended for the reservoir recess 13a (FIG. 10D). Then, the silicon substrate is immersed in an aqueous solution of potassium hydroxide (KOH) to form the reservoir recess 13a to a depth of about 150 μm and complete the nozzle communication holes 15 (FIG. 10E).

After the completion of wet etching, the remainder of the etching mask 91 is completely removed by etching using a hydrofluoric acid-based solution or the like. Then, the resulting silicon substrate is subjected to, for example, dry thermal oxidation to form a liquid blocking film 93 to a thickness of about 0.1 μm. The reservoir substrate 4 is thus completed (FIG. 10F).

In the third embodiment, pre-holes 92 are formed through the regions intended for the nozzle communication holes 15 by laser processing, and then these regions and the region intended for the reservoir recess 13a are subjected to wet etching to form the nozzle communication holes 15 and the reservoir recess 13a. Consequently, the reservoir substrate can be prepared in a shorter time and lower cost in comparison with the case where the nozzle communication holes 15 are formed by dry etching.

Fourth Embodiment

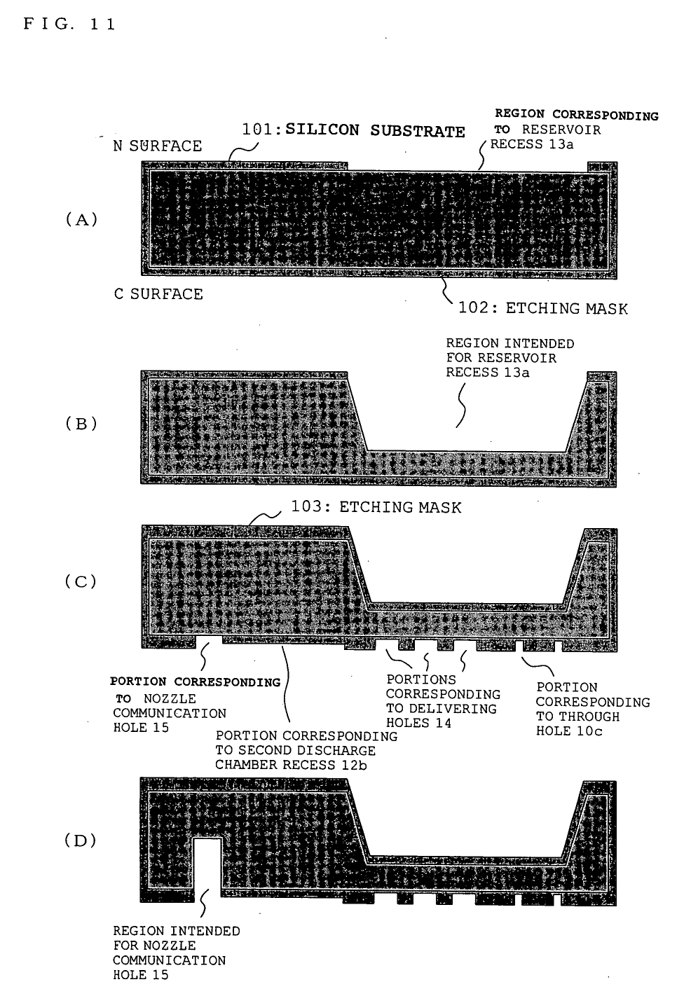

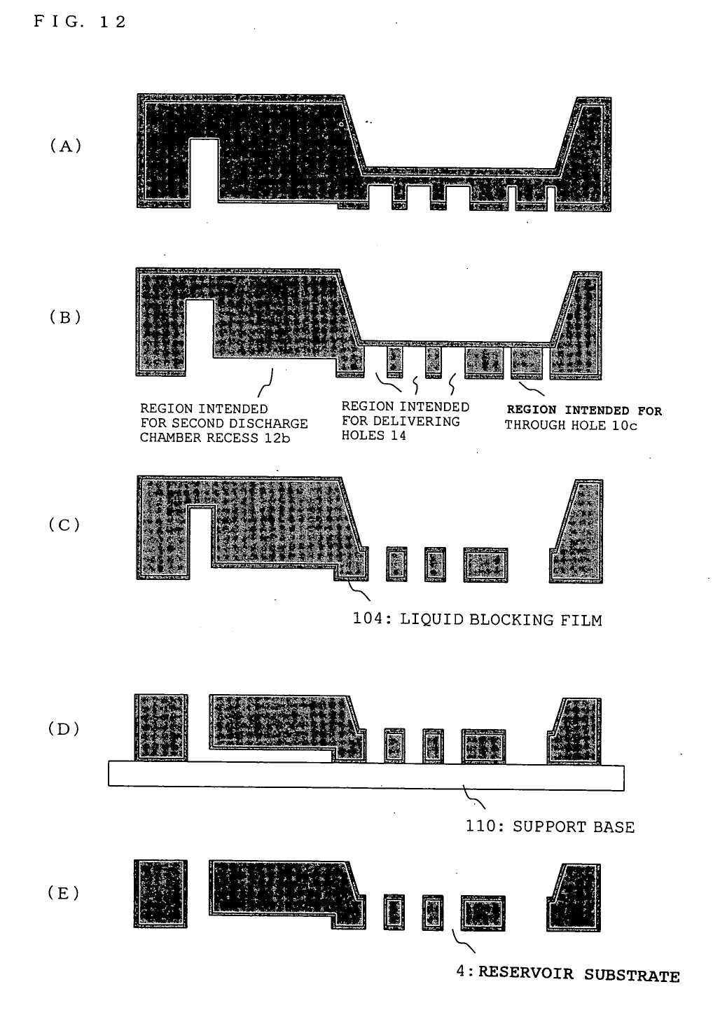

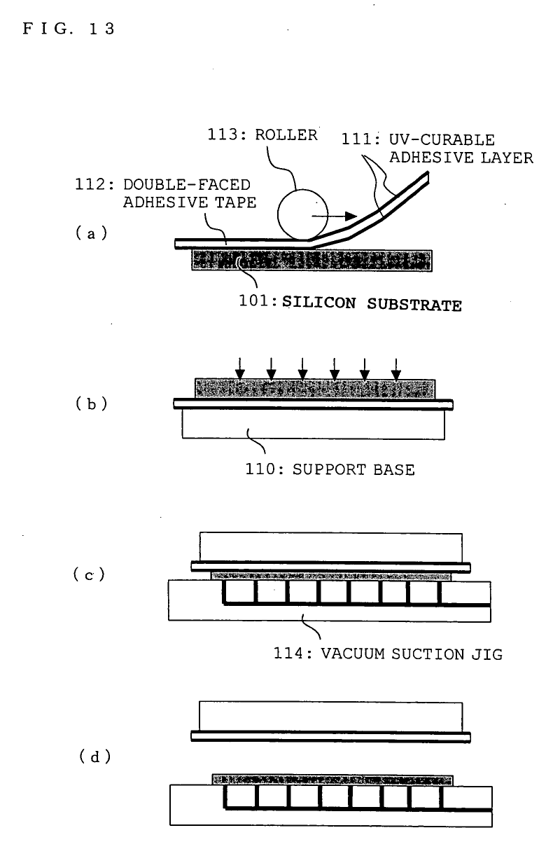

FIGS. 11A to 11D and 12A to 12E are process views of a reservoir substrate 4 of a liquid-jet head according to a fourth embodiment of the present invention. The preparation of the reservoir substrate 4 will be described with reference to these figures. While the foregoing embodiments use a (100)-oriented silicon substrate with a thickness of about 180 μm, the present embodiment uses an impact-resistant (100)-oriented silicon substrate 101 with a thickness of about 525 μm for the reservoir substrate 4. A silicon oxide etching mask 102 is formed over the entire surface of the silicon substrate 101 by thermal oxidation (in the present embodiment, wet thermal oxidation) or the like.

Subsequently, the portion corresponding to the reservoir 13 of the etching mask 102 is completely removed from the N surface side for wet-etching the region intended for the reservoir recess 13a (reservoir 13) (FIG. 11A). Then, the silicon substrate 101 is immersed in an aqueous solution of, for example, potassium hydroxide (KOH) to form a recess to a depth of about 495 μm in the region intended for the reservoir 13 by wet etching (FIG. 11B).

Then, the etching mask 102 is removed by etching using a hydrofluoric acid-based solution or the like. After the removal of the etching mask 102, the silicon substrate 101 is subjected to thermal oxidation or the like again to form another silicon oxide etching mask 103. In the present embodiment, the etching mask 103 serves as an etch stop layer and a leakage prevention layer, as well as serving as a mask. The etching mask 103 is patterned on the C surface side, followed by etching using a hydrofluoric acid-based solution. Thus, portions of the etching mask 103 corresponding to the nozzle communication holes 15, the second discharge chamber recesses 12b, the through hole 10c(liquid supply hole 10), and the delivering holes 14 are removed (FIG. 11C).

For the removal, as in the foregoing embodiments, the portions corresponding to the nozzle communication holes 15 of the etching mask 103 are completely removed to expose the surface of the silicon substrate 101, but the portions corresponding to the delivering holes 14, the through hole 10c, and the second discharge chamber recesses 12b of the etching mask 103 are subjected to half etching to be left partially. In this instance, the half etching is performed such that the portions corresponding to the delivering holes 14 and the through hole 10c of the etching mask have a smaller thickness than the portions corresponding to the second discharge chamber recesses 12b. For the through hole 10c, the entirety of the portion corresponding to the through hole 10c is not etched, but only the outer region is etched.

Then, the silicon substrate 101 is placed in the chamber 51 of the dry etching apparatus 50 as shown in FIG. 6, and dry-etched from the C surface side to form a hole of about 150 μm in depth (height) in the regions intended for the nozzle communication holes 15 (FIG. 11D).

Subsequently, half etching of the etching mask 103 is further performed so that the portions corresponding to the delivering holes 14 and the liquid supply hole 10 of the etching mask 103 are completely removed to expose the surface of the silicon substrate 101 and that the portions corresponding to the second discharge chamber recesses 12bof the etching mask 103 are partially left. Then, the regions intended for the nozzle communication holes 15, the delivering holes 14, and the through hole 10c are dry-etched to a depth of about 25 μm from the C surface side by, for example, ICP discharge (FIG. 12A). Consequently, the regions intended for the nozzle communication holes 15 are dry-etched to a depth of about 175 μm.

Then, half etching of the etching mask 103 is further performed to completely remove the remainder of the portions corresponding to the second discharge chamber recesses 12bof the etching mask 103 and thus to expose the silicon substrate 101. Subsequently, the C surface side is subjected to dry etching to a depth of about 25 μm by, for example, ICP discharge (FIG. 12B). Thus, the regions intended for the delivering holes 14 and for the outer region of the liquid supply hole 10 are completely dry-etched to be perforated while the etching mask 103 is left. Consequently, the regions intended for the nozzle communication holes 15 are dry-etched ultimately to a depth of about 200 μm. The etching mask 103, in the present embodiment, serves as the leakage prevention layer, as described above.

After the completion of dry etching, the remainder of the etching mask 103 is removed by etching using a hydrofluoric acid-based solution or the like. The resulting silicon substrate 101 with no etching mask 103 is subjected to, for example, dry thermal oxidation to form a liquid blocking film 104 to a thickness of, for example, about 0.1 μm (FIG. 12C). Subsequently, the silicon substrate 101 is fixed on a support base 110 with, for example, a double-faced adhesive tape, and ground to a predetermined thickness (FIG. 12D). In the present embodiment, the predetermined thickness is obtained by grinding.

FIGS. 13A to 13D are process views of the step of bonding the silicon substrate 101 to the support base 110 and separating them. In the present embodiment, a heat-resistant hard borosilicate glass substrate with a thickness of about 1 mm is used as the support base 110. The double-faced adhesive tape 112 includes UV-curable adhesive layers 111 on both surfaces. The adhesion strength of the UV-curable adhesive layers is weakened by irradiation of ultraviolet light. First, the double-faced adhesive tape 112 is bonded to the silicon substrate 101, using a roller 113 or the like so that air is not trapped between the silicon substrate 101 and the double-faced adhesive tape 112 (FIG. 13A). This step may be performed in a normal atmosphere. Then, the support base 110 is bonded to the surface of the silicon substrate 101 with intervention of the double-faced adhesive tape 112 in a vacuum in, for example, a vacuum chamber (FIG. 13B). Although an apparatus and a method for grinding is not particularly limited, for example, the silicon substrate 101 can be ground to about 345 μm by CMP grinding. After grinding, the workpiece is cleaned.

After grinding and cleaning, the workpiece is fixed on a vacuum suction jig 114 with the silicon substrate 101 (reservoir substrate 4) in contact with the jig (FIG. 13C). Then, the double-faced adhesive tape 112 is irradiated with ultraviolet (UV) light from the support base 110 side in a nitrogen (N₂) atmosphere to weaken the adhesion strength, and thus the silicon substrate 101 (reservoir substrate 4) is separated from the support base 110 and the double-faced adhesive tape 112 (FIG. 13D).

Thus the reservoir substrate 4 is completed (FIG. 12E). The completed reservoir substrate 4 is stacked and bonded together with the other substrates in this order: the electrode substrate 2, the cavity substrate 3, the reservoir substrate 4, and the nozzle substrate 5. The stack is diced so that the liquid-jet head (head chips) prepared on a wafer are separated from each other. The liquid-jet head is thus completed.

In the fourth embodiment, recesses and holes are formed in a silicon substrate 101 having a thickness larger than that of the intended reservoir substrate 4 in the regions intended for the reservoir 13, the nozzle communication holes 15, the second discharge chamber recesses 12b, the through hole 10c (liquid supply hole 10), and the delivering holes 14. Then, the silicon substrate 101 with the larger thickness is ground on a support base 110 to produce the reservoir substrate 4. This process allows stable transfer of the silicon substrate, prevents breakage, and enhances the workability of the silicon substrate, even if the silicon substrate has an increased diameter for mass production. Also, since the silicon substrate 101 does not need to originally have an intended thickness of the reservoir substrate 4, inexpensive standardized silicon substrate can be used for the reservoir substrate 4, and thus the material cost can be reduced. Furthermore, the process of the fourth embodiment can be applied to the preparation of thinner liquid-jet heads (reservoir substrates).

Fifth Embodiment

In the foregoing embodiments, the etching mask used for preparing the reservoir substrate doubles as the leakage prevention layer. In the present embodiment, the leakage prevention layer is not limited to the etching mask. For example, another layer different from the etching mask may be provided onto the silicon substrate for preventing the cooling gas from leaking, and through holes or the like are formed in the silicon substrate in this state.

Sixth Embodiment

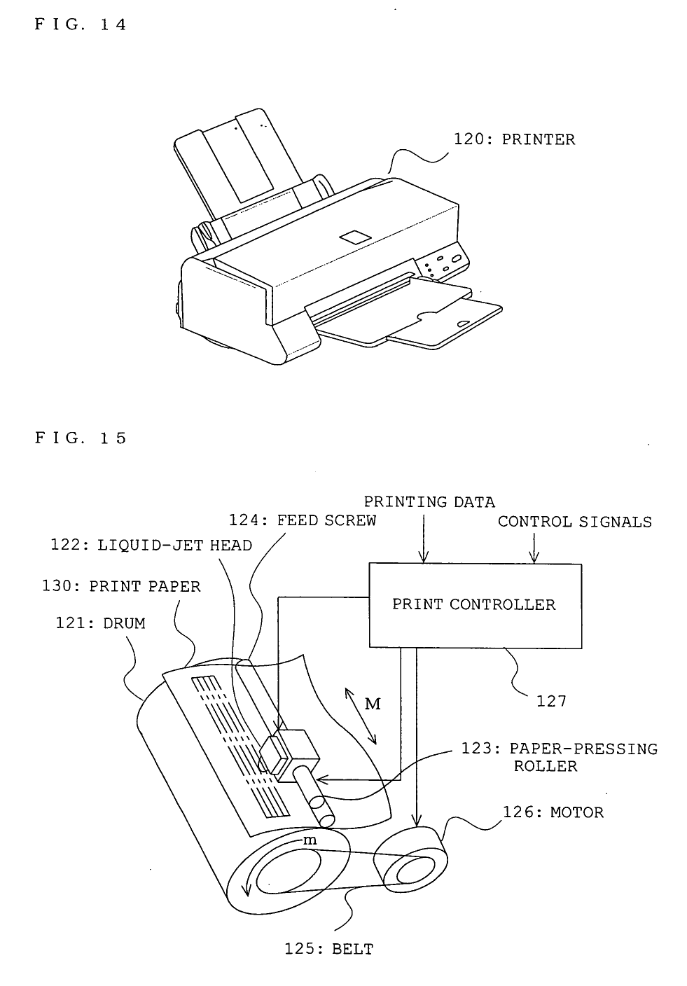

FIG. 14 is an external view of a liquid-jet apparatus including a liquid-jet head produced in any one of the foregoing embodiments. FIG. 15 is a schematic view of an example of major components constituting the liquid-jet apparatus. The liquid-jet apparatus shown in FIGS. 14 and 15 is intended to print by liquid-jetting (ink-jetting), and is of so-called serial type. As shown in FIG. 15, the liquid-jet apparatus mainly includes a drum 121 for supporting print paper 130, or an object to be subjected to printing, and the liquid-jet head 122 for jetting ink onto the print paper 130 for recording. In addition, an ink feed unit (not shown) is included for feeding ink to the liquid-jet head 122. The print paper 130 is brought into press-contact with the drum 121 by a paper-press roller 123 provided in parallel to the axis of the drum 121, and is thus supported by the drum 121. A feed screw 124 is provided in parallel to the axis of the drum 121 to hold the liquid-jet head 122. The liquid-jet head 122 is shifted in the axial direction of the drum 121 by rotating the feed screw 124.

The drum 121 is driven to rotate by a motor 126 with aid of a belt 125 or the like. A print controller 127 is also provided. The print controller 127 operates the feed screw 124 and the motor 126 according to printing data and control signals, and, in addition, operates an oscillation drive circuit (not shown) to vibrate the vibration plate 4, thus controlling the liquid-jet apparatus for printing on the print paper 130.

While ink is used as the liquid jetted onto the print paper 130 from the liquid-jet head in the present embodiment, the liquid is not limited to ink. For example, if the liquid is jetted onto a substrate intended for a color filter, the liquid may contain a pigment for the color filter; if the liquid is jetted onto a substrate for an OEL display panel or the like, the liquid may contain a luminescent compound; if the liquid is jetted for electrical wiring on a substrate, the liquid may contain an electroconductive metal. In another application, the liquid-jet head may be used as a dispenser for jetting a liquid onto a substrate to prepare a microarray of biomolecules, and the liquid may contain a probe for DNA (deoxyribonucleic acid), other nucleic acids such as RNA (ribonucleic acid) and PNA (peptide nucleic acid), or protein. Furthermore, the liquid-jet head may jet a dye for coloring cloth.

1. A liquid-jet head comprising:
a nozzle substrate having a plurality of nozzle holes through which liquid is jetted as droplets;
a cavity substrate including vibration plates for applying pressure to the liquid and a plurality of first recesses corresponding to the respective nozzle holes; and
a reservoir substrate having a second recess which serves as a reservoir for storing liquid to be supplied to the first recesses, a plurality of delivering holes which are formed in the bottom of the second recess to allow the second recess to communicate with the first recesses, a plurality of nozzle communication holes which allow the first recesses to communicate with the respective nozzle holes, and a plurality of third recesses which are formed on the opposite side to the second recess, corresponding to the respective first recesses,
wherein the reservoir substrate is bonded to the cavity substrate so that the third recesses are coupled with the respective first recesses to define discharge chambers.

2. (cancelled)

3. The liquid-jet head according to claim 1, wherein the reservoir substrate is made of a single crystal silicon substrate whose surface is oriented in the (100) plane.

4. The liquid-jet head according to claim 1, wherein the third recesses each have a height of 0.8 to 1.0 time that of the first recesses and a width of 0.3 to 0.5 time that of the first recesses.

5. The liquid-jet head according to claim 1, wherein the nozzle communication holes directly communicate with the respective third recesses in a multi-step structure.

6. A liquid-jet apparatus including the liquid-jet head according to claim 1.

7. A method for manufacturing a liquid-jet head including a plurality of nozzles through which liquid is jetted as droplets, a plurality of discharge chambers each having a vibration plate for applying pressure to the liquid, and a reservoir for storing the liquid to be supplied to the discharge chambers, the method comprising:
a step of preparing a reservoir substrate, the step including sub steps of: forming a recess in a substrate by wet etching, the recess being intended for the reservoir; and forming delivering holes serving as passages between the discharge chambers and the reservoir, nozzle communication holes serving as passages between the discharge chambers and the nozzles, and a plurality of recesses intended for part of the discharge chambers, in the substrate by dry etching.

8. A method for manufacturing a liquid-jet head including a plurality of nozzles through which liquid is jetted as droplets, a plurality of discharge chambers each having a vibration plate for applying pressure to the liquid, and a reservoir for storing the liquid to be supplied to the discharge chambers, the method comprising:
a step of preparing a reservoir substrate, the step including the sub steps of: forming delivering holes serving as passages between the discharge chambers and the reservoir, and a plurality of recesses intended for part of the discharge chambers, in a substrate by dry etching; forming pre-holes for forming nozzle communication holes serving as passages between the discharge chamber and the nozzles, in the substrate by laser processing; and then forming the nozzle communication holes and a recess intended for the reservoir in the substrate by wet etching.

9. The method according to claim 7, wherein the dry etching is performed using a silicon oxide film as an etching mask, and wherein a portion of the etching mask corresponding to a region to be etched to the greatest depth is first removed and then the substrate is dry-etched, subsequently a portion of the etching mask corresponding to a region to be etched to the second greatest depth is removed and then the substrate is dry-etched again, and the dry etching is thus repeated in decreasing order of etching depth to form a multi-step structure in the substrate.

10. The method according to claim 7, wherein the dry etching is preformed using a resist mask, and wherein a portion of the resist mask corresponding to a region to be etched to the greatest depth is first removed and then the substrate is dry-etched, subsequently a portion of the resist mask corresponding to a region to be etched to the second greatest depth is removed and then the substrate is dry-etched again, and the dry etching is thus repeated in decreasing order of etching depth to form a multi-step structure in the substrate.

11. (cancelled)

12. (cancelled)

13. (cancelled)

14. The method according to claim 7, wherein the step of preparing the reservoir substrate further includes a sub step of forming a leakage prevention layer for preventing the leakage of a cooling gas on a surface, which is oppositely fixed on a supporting stand having a recess for cooling the substrate with the cooling gas delivered to the recess during the dry etching, before perforating the substrate to form the nozzle communication holes.

15. The method according to claim 14, wherein the substrate is made of silicon and the leakage prevention layer is formed by thermal oxidation of the silicon substrate.

16. The method according to claim 7, further comprising a sub step of grinding the reservoir substrate to reduce the thickness of the reservoir substrate to a predetermined thickness.

17. The method according to claim 7, further comprising steps of:
preparing an electrode substrate including electrodes for actuating the vibration plates, a cavity substrate including the discharge chambers, and a nozzle substrate including the nozzles; and
stacking and bonding the electrode substrate, the cavity substrate, the reservoir substrate, and the nozzle substrate in that order.

18. A method for manufacturing a liquid-jet apparatus comprising a step of preparing the liquid-jet head by the method according to claim 7.

19. The method according to claim 8, wherein the dry etching is performed using a silicon oxide film as an etching mask, and wherein a portion of the etching mask corresponding to a region to be etched to the greatest depth is first removed and then the substrate is dry-etched, subsequently a portion of the etching mask corresponding to a region to be etched to the second greatest depth is removed and then the substrate is dry-etched again, and the dry etching is thus repeated in decreasing order of etching depth to form a multi-step structure in the substrate.

20. The method according to claim 8, wherein the dry etching is preformed using a resist mask, and wherein a portion of the resist mask corresponding to a region to be etched to the greatest depth is first removed and then the substrate is dry-etched, subsequently a portion of the resist mask corresponding to a region to be etched to the second greatest depth is removed and then the substrate is dry-etched again, and the dry etching is thus repeated in decreasing order of etching depth to form a multi-step structure in the substrate.

21. The method according to claim 8, wherein the step of preparing the reservoir substrate further includes a sub step of forming a leakage prevention layer for preventing the leakage of a cooling gas on a surface, which is oppositely fixed on a supporting stand having a recess for cooling the substrate with the cooling gas delivered to the recess during the dry etching, before perforating the substrate to form the nozzle communication holes.

22. The method according to claim 21, wherein the substrate is made of silicon and the leakage prevention layer is formed by thermal oxidation of the silicon substrate.

23. The method according to claim 8, further comprising a sub step of grinding the reservoir substrate to reduce the thickness of the reservoir substrate to a predetermined thickness.

24. The method according to claim 8, further comprising steps of:
preparing an electrode substrate including electrodes for actuating the vibration plates, a cavity substrate including the discharge chambers, and a nozzle substrate including the nozzles; and
stacking and bonding the electrode substrate, the cavity substrate, the reservoir substrate, and the nozzle substrate in that order.

25. A method for manufacturing a liquid-jet apparatus comprising a step of preparing the liquid-jet head by the method according to claim 8.
